(19) United States
(12) Patent Application Publication
(10) Pub. No.: US 2017/0270416 A1
(43) Pub. Date: Sep. 21, 2017

(54) METHOD AND APPARATUS FOR BUILDING PREDICTION MODELS FROM CUSTOMER WEB LOGS

(71) Applicant: 24/7 Customer, Inc., Campbell, CA (US)

(72) Inventors: R. Mathangi SRI, Bangalore (IN); Bhupinder SINGH, Bangalore (IN)

(21) Appl. No.: 15/459,495

(22) Filed: Mar. 15, 2017

Related U.S. Application Data
(60) Provisional application No. 62/309,321, filed on Mar. 16, 2016.

(51) Int. Cl. G06N 5/04; G06N 99/00

(52) U.S. Cl. CPC G06N 5/04; G06N 99/005

(57) ABSTRACT

A computer-implemented method and an apparatus to facilitate building of prediction models from customer Web logs includes receiving a Web log including unstructured data and structured data corresponding to a customer's journey on a Website. The structured data in the Web log is used to generate structured variables and the unstructured data in the Web log is used to generate unstructured variables. The generated structured and unstructured variables are concatenated to form a session string, which serves as a textual representation of the customer's journey on the Website. The session string is subjected to text-based processing to generate a plurality of features. The plurality of features are used to build one or more prediction models for facilitating prediction of at least one response variable corresponding to the customers visiting the Website.

### CROSS REFERENCE TO RELATED APPLICATIONS

This application claims priority to U.S. provisional patent application Ser. No. 62/309,321, filed Mar. 16, 2016, which application is incorporated herein in its entirety by this reference thereto.

### TECHNICAL FIELD

Embodiments of the invention generally relate to prediction models for use in customer modeling, and more particularly to a method and apparatus for building prediction models from customer Web logs.

### BACKGROUND

Many enterprises aim to predict intentions of their customers to improve chances of a sale or to provide an enriched customer experience. To that effect, the enterprises may maintain a record of customer activity on respective enterprise interaction channels. For example, customer activity on enterprise Websites may be recorded in form of Web logs. The Web logs are then processed in real-time or in an offline manner to predict intentions of the customers.

Typically, a Web log captures structured data, such as for example, a type of device used by the customer for accessing the enterprise Website (for example, a mobile device or a desktop), an operating system associated with the device, a type of Web browser used for accessing the Website, a day/time information associated with Website access, and the like. The Web log may also capture information related to Web pages visited by the customer and the time stamps associated with each Web page accessed by the customer. To facilitate capture of such information, Web pages of an enterprise Website are manually categorized and rules are pre-defined for Web page access, such that a flag or a category label (or any such indication) is recorded in a Web log, every time a customer visits a particular Web page. For example, if a customer visits a Web page associated with processing of a payment on the enterprise Website, then a flag or a category label of “process payment” may be recorded in the Web log. Similarly, if the customer visits a Web page associated with frequently asked questions (FAQs), then a flag or a category label of “FAQ” may be recorded in the Web log. The captured structured information (for example, type of device/browser, day/time information, etc.) along with recorded flags or category labels based on manual or rule-based categorization are then subjected to exploratory data analysis to identify variables that may be used for building prediction models for the customers visiting the enterprise Website.

Such approaches to building prediction models for the customers involve substantial time and manual effort, for example, in categorization of Web pages and exploratory data analysis of recorded content. Moreover, current approaches to capturing customer activity on Websites, such as for example by using page categories and rules, result in a loss of rich information, such as actual URLs, or query strings (key-value pairs after “?”) or the sequence of the URLs, sequence of click events, sequence of scroll events, sequence of texts filled in a form on a Webpage, or sequence of times spent on each page, etc. which may provide important signals for building predicting models for customers visiting the enterprise Website.

Accordingly, there is a need to facilitate building of prediction models for customers, which preclude time and manual effort in categorizing Web pages and exploratory data analysis. Moreover, there is a need to capture and use unstructured data more efficiently and combine the unstructured data with structured data for facilitating building of prediction models.

### SUMMARY

In an embodiment of the invention, a computer-implemented method for building prediction models from customer Web logs is disclosed. The method receives, by a processor, a Web log including unstructured data and structured data corresponding to a customer's journey on a Website. The method generates by the processor, using the Web log: (1) a plurality of unstructured variables from the unstructured data, and (2) a plurality of structured variables from the structured data. The method generates, by the processor, a session string by concatenating the plurality of unstructured variables and the plurality of structured variables. The session string configures a textual representation of the customer's journey on the Website. The method performs, by the processor, a text-based processing of the session string to generate a plurality of features. The method builds, by the processor, at least one prediction model using the plurality of features. The at least one prediction model is configured to facilitate prediction of at least one response variable.

In another embodiment of the invention, an apparatus for building prediction models from customer Web logs is disclosed. The apparatus includes at least one processor and a memory. The memory has stored therein machine executable instructions, that when executed by the at least one processor, cause the apparatus to receive a Web log comprising unstructured data and structured data corresponding to a customer's journey on a Website. The apparatus generates using the Web log: (1) a plurality of unstructured variables from the unstructured data, and (2) a plurality of structured variables from the structured data. The apparatus generates a session string by concatenating the plurality of unstructured variables and the plurality of structured variables. The session string configures a textual representation of the customer's journey on the Website. The apparatus performs a text-based processing of the session string to generate a plurality of features. The apparatus builds at least one prediction model using the plurality of features. The at least one prediction model is configured to facilitate prediction of at least one response variable.

In another embodiment of the invention, a computer-implemented method for building prediction models is disclosed. The method receives, by a processor, unstructured data and structured data corresponding to a customer's journey on one or more enterprise interaction channels associated with an enterprise, where an enterprise interaction channel from among the one or more enterprise interaction channels corresponds to an enterprise Website. The method generates, by the processor, a plurality of unstructured variables from the unstructured data and a plurality of structured variables from the structured data. The method generates, by the processor, a session string by concatenating the plurality of unstructured variables and the plurality of structured variables. The session string configures a textual representation of the customer's journey on the one or more enterprise interaction channels. The method performs, by the processor, a text-based processing of the session string to generate a plurality of features. The method builds, by the processor, at least one prediction model using the plurality of features. The at least one prediction model is configured to facilitate prediction of at least one response variable.

### BRIEF DESCRIPTION OF THE FIGURES

FIG. 1 shows a schematic diagram illustrating a customer browsing an enterprise Website in accordance with an embodiment of the invention;

FIG. 2 depicts a portion of a Web log including captured data related to a customer's journey on a Website, in accordance with an embodiment of the invention;

FIG. 3 is a block diagram of an apparatus configured to facilitate building of prediction models from customer Web logs, in accordance with an embodiment of the invention;

FIG. 4 is an example representation of session string generated corresponding to customer's journey on an enterprise Website, in accordance with an embodiment of the invention;

FIG. 5 is a flow diagram of an example method for building prediction models from a customer Web log, in accordance with an embodiment of the invention; and

FIG. 6 is a flow diagram of an example method for building prediction models for customers of an enterprise, in accordance with another embodiment of the invention.

### DETAILED DESCRIPTION

The detailed description provided below in connection with the appended drawings is intended as a description of the present embodiments of the invention and is not intended to represent the only forms in which the invention may be constructed or used. However, the same or equivalent functions and sequences may be accomplished by different embodiments.

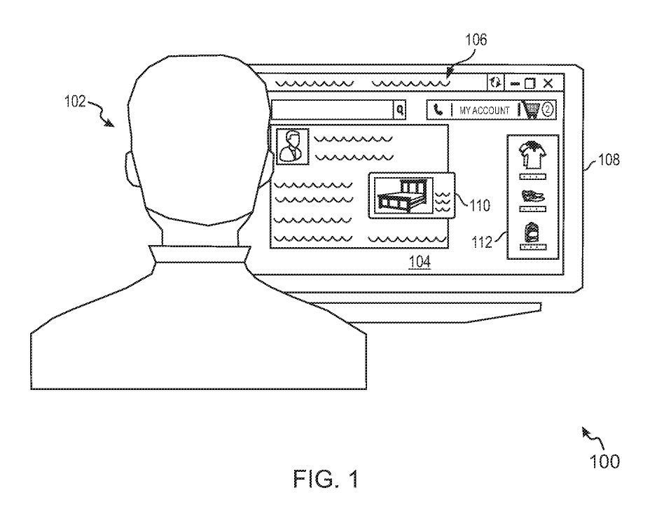

FIG. 1 shows a schematic diagram 100 illustrating a customer 102 browsing an enterprise Website 104 in accordance with an embodiment of the invention. The customer 102 is depicted to use a Web browser application 106 installed on a desktop computer 108 for accessing and browsing the enterprise Website 104. Some non-limiting examples of the enterprise Website 104 (hereinafter referred to as the Website 104) may include an enterprise Website displaying products and/or services offered for sale, a news aggregator portal, an e-commerce Website, a gaming or sports content related Website, a social networking Website, an educational content related portal, and the like. The Website 104 may be hosted on a remote Web server and the Web browser application 106 may be configured to retrieve one or more Web pages associated with the Website 104 from the remote Web server over a network (not shown in FIG. 1). Examples of the network may include wired networks, wireless networks, or a combination thereof. Examples of the wired networks may include Ethernet, local area networks (LAN), fiber-optic cable networks, and the like. Examples of the wireless networks may include cellular networks like GSM/3G/4G/CDMA networks, wireless LAN, blue-tooth or Zigbee networks, and the like. An example of a combination of the wired and wireless networks may include the Internet. It is understood that the Website 104 may attract a large number of existing and potential customers, such as the customer 102.

In an embodiment of the invention, the Website 104 may be an e-commerce Website displaying a variety of products and services for sale to the customers during their journey on the Website 104. Additionally, the e-commerce Website may also display widgets, such as widgets 110 and advertisements, such as advertisements 112, to the customer 102 during the customer's journey on the Website. The term ‘journey’ as used herein refers to a path a customer may take to achieve an objective for visiting the Website 104. For example, the journey of the customer 102 on the Website 104 may include a number of Web page visits and decision points that carry the Web interaction of the customer 102 from one step to another step.

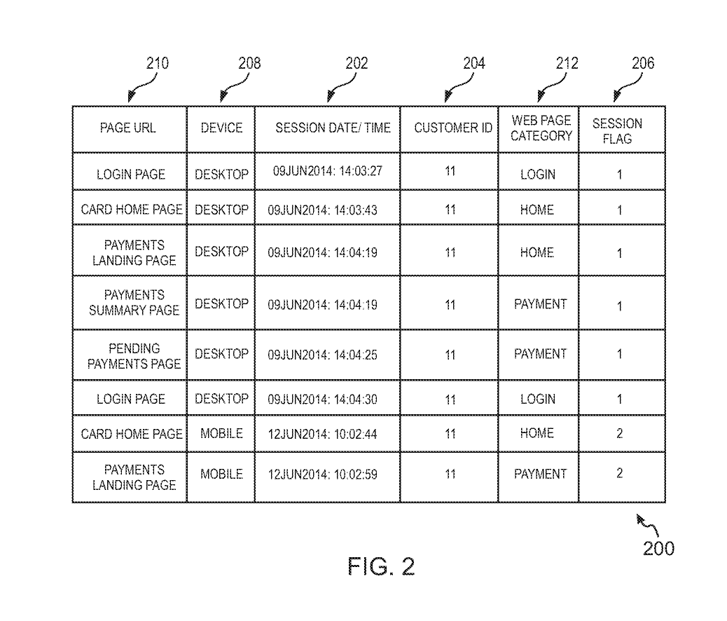

Typically, most enterprises aim to predict intentions of their customers to improve chances of a sale or to provide an enriched customer experience. To that effect, an enterprise may record activity of the customers on enterprise interaction channels. For example, the activity of the customer 102, on the Website 104 may be recorded in form of a Web log. A snapshot of a portion of an example Web log is depicted in FIG. 2.

FIG. 2 depicts a portion of a Web log 200 including captured data related to a customer's journey on a Website, in accordance with an example scenario. The tabular form of the Web log 200 is shown for illustration purposes. In some example scenarios, the Web log may be formulated in other formats, such as for example in a relational database format, and the like. It can be deduced from column 202 in the Web log 200 that the customer (associated with a customer ID 11 as shown in column 204) has visited the enterprise Website twice, i.e. on June 9 and June 12 and accordingly the Web log 200 captures information related to two Web sessions of the customer on the Website (as exemplarily depicted by session flags 1 and 2 in column 206). In addition to the date and time information corresponding to the Web sessions as shown in the column 202, the Web log 200 captures the devices used for visiting the Website (as exemplarily depicted in column 208). For example, the customer used a desktop device, such as the desktop 108 shown in FIG. 1, for accessing the Website the first time and thereafter a mobile device for accessing the Website again. Moreover, the Web log also captures the Web pages visited by the customer and the broad categories of the Web pages (such as a Login page, home page and a payment page) as exemplarily depicted in columns 210 and 212, respectively.

The captured structured information (for example, type of device/browser, day/time information, etc.) along with session flags and Web page visit information is subjected to exploratory data analysis to identify distribution of variables that may be used for building a prediction model for the customers visiting the enterprise Website.

However, such an approach to building prediction models for the customers involves substantial time and manual effort, for example, in categorization of Web pages and exploratory data analysis of recorded content. Moreover, capturing URL related information in terms of page categories reduces a richness of information (such as for example, a sequence of pages, sequence of times spent on pages, the nature of customer query that resulted in the Web page being retrieved, etc.), which may provide important signals for generating predictions for the customer visiting the enterprise Website.

Various embodiments of the invention provide a method and apparatus that are capable of overcoming these and other obstacles and providing additional benefits. More specifically, various embodiments of the invention disclosed herein present a text mining based approach for building prediction models for customers from Web logs. The text mining based approach for building a prediction model for a customer (or a set of customers) from Web logs involves two processing steps. In the first processing step, structured information is converted into textual form and concatenated with other unstructured data to generate an unstructured freeform session string, which serves as a text representative of the customer's journey on the Website. In the second processing step, features are derived from the session string using text categorization tools and the features are then provided to models based on intention prediction algorithms for facilitating building of prediction models configured to predict, for example customer intentions or any other response variables related to the customer, such as for example, customer persona, likelihood of the customer to call, outcome of a chat (e.g. a sale/no-sale outcome, an escalation to a live agent outcome or a voice referral outcome, etc.). An apparatus for building prediction models for customers from Web logs is explained with reference to FIG. 2.

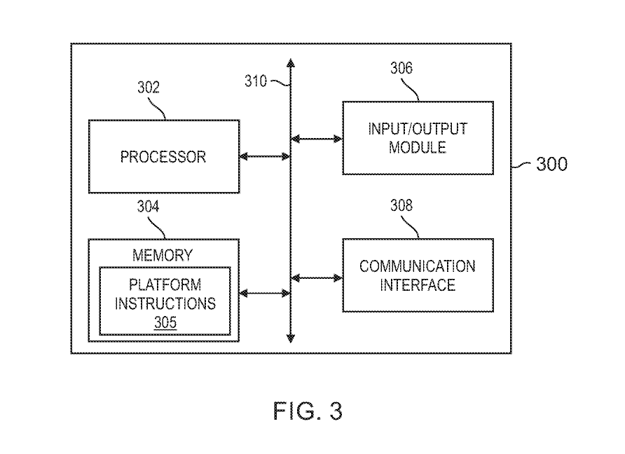

FIG. 3 is a block diagram of an apparatus 300 configured to facilitate building of prediction models for customers of an enterprise, in accordance with an embodiment of the invention. The term ‘enterprise’ as used herein may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise. Moreover, the term ‘customer’ as used herein refers to an existing user or a potential user of enterprise offerings, such as product offerings, service offerings, information offerings, and the like. In some embodiments of the invention, the term ‘customer’ may include individuals, group of individuals or even other enterprise entities. Furthermore, the term ‘building of prediction models’ as used herein refers to training of classification algorithms such that upon receiving an input related to transformed customer data (such an input is also referred to herein as ‘features’), a classification algorithm can predict a likelihood of a desired outcome (such as whether the customer is likely to make a purchase during the current Web journey or not, and the like), thereby in effect modeling customer behavior.

The apparatus 300 includes at least one processor, such as a processor 302 and a memory 304. Although the apparatus 300 is depicted to include only one processor, the apparatus 300 may include more number of processors therein. In an embodiment, the memory 304 is capable of storing machine executable instructions, referred to herein as platform instructions 305. Further, the processor 302 is capable of executing the platform instructions 305. In an embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 302 may be configured to execute hard-coded functionality. In an embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories, such as mask ROM, PROM (programmable ROM), EPROM (erasable PROM), flash memory, RAM (random access memory), etc.

The apparatus 300 also includes an input/output module 306 (hereinafter referred to as ‘I/O module 306’) and at least one communication interface such as the communication interface 308. In an embodiment, the I/O module 306 may include mechanisms configured to receive inputs from and provide outputs to the user of the apparatus 300. To that effect, the I/O module 306 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 302 may include I/O circuitry configured to control at least some functions of one or more elements of the I/O module 306 such as, for example, a speaker, a microphone, a display, and/or the like. The processor 302 and/or the I/O circuitry may be configured to control one or more functions of the one or more elements of the I/O module 306 through computer program instructions, for example, software and/or firmware, stored on a memory, for example, the memory 304, and/or the like accessible to the processor 302.

The communication interface 308 may include several channel interfaces to communicate with a plurality of enterprise interaction channels. Some non-exhaustive examples of the enterprise interaction channels may include a Web channel (i.e. an enterprise Website), a voice channel (i.e. voice-based customer support), a chat channel (i.e. a chat support), a native mobile application channel, a social media channel, and the like. Each channel interface may be associated with a respective communication circuitry such as for example, a transceiver circuitry including antenna and other communication media interfaces to connect to a wired and/or wireless communication network. The communication circuitry associated with each channel interface may, in at least some example embodiments, enable transmission of data signals and/or reception of signals from remote network entities, such as Web servers hosting enterprise Website or a server at a customer support and service center configured to maintain real-time information related to interactions between customers and agents.

In at least one example embodiment, the channel interfaces are configured to receive up-to-date information related to the customer-enterprise interactions from the enterprise interaction channels. In some embodiments, the information may also be collated from the plurality of devices used by the customers. To that effect, the communication interface 308 may be in operative communication with various customer touch points, such as electronic devices associated with the customers, Websites visited by the customers, devices used by customer support representatives (for example, voice agents, chat agents, IVR systems, in-store agents, and the like) engaged by the customers, and the like.

The communication interface 308 may further be configured to receive information related to current journeys of customers on enterprise interaction channels, such as enterprise Websites, enterprise native mobile applications, enterprise social media forums, etc. in real-time and provide the information to the processor 302. In at least some embodiments, the communication interface 308 may include relevant Application Programming Interfaces (APIs) to communicate with remote data gathering servers associated with such enterprise interaction channels. Moreover, the communication between the communication interface 308 and the remote data gathering servers may be realized over various types of wired or wireless networks.

In an embodiment, various components of the apparatus 300, such as the processor 302, the memory 304, the I/O module 306, and the communication interface 308 are configured to communicate with each other via or through a centralized circuit system 310. The centralized circuit system 310 may be various devices configured to, among other things, provide or enable communication between the components (302-308) of the apparatus 300. In certain embodiments, the centralized circuit system 310 may be a central printed circuit board (PCB), such as a motherboard, a main board, a system board, or a logic board. The centralized circuit system 310 may also, or alternatively, include other printed circuit assemblies (PCAs) or communication channel media.

The apparatus 300 as illustrated and hereinafter described is merely illustrative of an apparatus that could benefit from embodiments of the invention and, therefore, should not be taken to limit the scope of the invention. The apparatus 300 may include fewer or more components than those depicted in FIG. 3. In an embodiment, the apparatus 300 may be implemented as a platform including a mix of existing open systems, proprietary systems, and third party systems. In another embodiment, the apparatus 300 may be implemented completely as a platform including a set of software layers on top of existing hardware systems. In an embodiment, one or more components of the apparatus 300 may be deployed in a Web Server. In another embodiment, the apparatus 300 may be a standalone component in a remote machine connected to a communication network and capable of executing a set of instructions (sequential and/or otherwise) to facilitate building of prediction models for customers of an enterprise. Moreover, the apparatus 300 may be implemented as a centralized system, or, alternatively, the various components of the apparatus 300 may be deployed in a distributed manner while being operatively coupled to each other. In an embodiment, one or more functionalities of the apparatus 300 may also be embodied as a client within devices, such as customers' devices. In another embodiment, the apparatus 300 may be a central system that is shared by or accessible to each of such devices.

The building of prediction models by the apparatus 300 is hereinafter explained with reference to customer of an enterprise. The apparatus 300 may be caused to build prediction models for several customers of the enterprise in a similar manner.

In at least one example embodiment, the processor 302 is configured to, with the content of the memory 304, cause the apparatus 300 to receive a Web log including unstructured data and structured data corresponding to a customer's journey on a Website. As explained above, the communication interface 308 of the apparatus 300 is coupled with Web servers and other data gathering servers for receiving information related to the customer's journey on one or more enterprise interaction channels. In an illustrative embodiment, content pieces such as images, hyperlinks, URLs, and the like, displayed on an enterprise Website may be associated with Hypertext Markup Language (HTML) tags or JavaScript tags that are configured to be invoked upon user selection of tagged content. The information corresponding to the customer's activity on the enterprise Website may then be captured by recording an invoking of the tags in a Web server (i.e. a data gathering server) hosting the enterprise Website. In some embodiments, a socket connection may be implemented to capture all information related to the customer activity on the Website.

Accordingly, various types of structured and unstructured data may be captured corresponding to the customer's journey on the Website. In an embodiment, the structured data captured corresponding to the customer's journey on the Website includes information related to at least one of a type of device used by the customer for accessing the Website, an operating system associated with the device, a type of Web browser used for accessing the Website, and a time-stamp associated with the Website access. In an embodiment, unstructured data captured corresponding to a customer's journey on the enterprise Website may include information such as Web pages visited on the Website, images viewed, hyperlinks accessed, mouse roll-over events, clickstream data, keystroke patterns, and the like. In at least one example embodiment, the apparatus 300 may be configured to cause capture of complete Uniform Resource Locators (URLs) of Web pages visited by the customer during the customer's journey on the Website. The URLs of the Web pages may be captured as part of unstructured data. Capturing complete URLs provides several advantages, as is explained below.

In at least one example embodiment, the structured data and the unstructured data captured corresponding to the customer's journey on the Website may be recorded in form of a Web log, such as the Web log depicted in FIG. 2. However, the content captured within the Web log includes several important differences over Web logs used by conventional mechanisms. For example, conventional Web logs use flags and/or category labels for Web pages visited, whereas the Web log captured as per embodiments of the invention precludes such data capture. Instead, the Web logs records complete URLs of Web pages visited by the user.

In an illustrative example, if a customer has visited a number of Web pages on an enterprise Website associated with following URLs:

www.mypersonalbanking.com/us/en/home.html
www.mypersonalbanking.com/us/en/send-money/start.html
www.mypersonalbanking.com/us/en/send-money/sendMoneyLogin.html
www.mypersonalbanking.com/us/en/send-money/receiverinformation.html
www.mypersonalbanking.com/us/en/send-money/paymentinformation.html
www.mypersonalbanking.com/us/en/send-money/confirmidentity.html
www.mypersonalbanking/us/en/send-money/review.html
www.mypersonalbanking.com/us/en/send-money/declineOptions.html

Then, the processor 302 may be configured to store the URLs in an as-is form as unstructured data in the Web log. Recording of complete URLs enables extracting several critical pieces of hints corresponding to the customer's journey on the Website. For example, a sequence of Web page visited, a search query entered by the user to fetch the Web page (such information can be deducted from key-value pairs in the URL), and the like may be obtained from the complete URLs. Moreover, capturing of URLs as-is in the Web logs also precludes manual categorization of Web pages and assignment of flags/category labels for each Web page, which is cumbersome for the user of the apparatus 300. The apparatus 300 may provision a request for information using a particular schema from the data gathering servers/Web servers and, as such, facilitate capture of Web logs including the desired structured and unstructured data. The Web logs including such information may then be provisioned by the data gathering servers/Web servers to the communication interface 308 of the apparatus 300, which may then provision the received Web log including the structured and unstructured data to the processor 302. The communication interface 308 may be configured to provide the received structured and unstructured data to the processor 302 directly or to store the information in the memory 304 for subsequent access by the processor 302. It is noted that in some embodiments, the customer's journey on the Website may include one or more visits to the Website. Moreover, one or more Web logs may be received during the current journey of the customer on the Website so as to provide the apparatus 300 with information related to the current journey in an on-going manner in real-time.

In at least one embodiment, the processor 302 is configured to, with the content of the memory 304, cause the apparatus 300 to generate a plurality of unstructured variables from the unstructured data, and a plurality of structured variables from the structured data using the Web log. In an embodiment, the processor 302 of the apparatus 300 may be caused to parse the URLs to obtain tokens corresponding to at least one of domain names, hierarchy of journey, destination pages, and query strings. Each token obtained by parsing the URLs may configure an unstructured variable from among the plurality of unstructured variables. In an embodiment, the unstructured variables generated from the unstructured data comprises at least one unstructured variable from among variables related to a time spent on each Web page, a sequence of Web page visits and a search query entered by the customer during the customer's journey on the Website.

In an illustrative embodiment, if the customer executes a query on the enterprise Website such that the query results in an URL exemplarily depicted as follows:

www.mypersonalbanking.com/us/en/myaccounts.html?token1=value1&&token2=value 2′

Then, in such a scenario, the processor 302 may be configured to use a URL parser to parse the above URL to generate three unstructured variables as follows: ‘www.mypersonalbanking.com/en/us/my accounts.html?’; ‘Key1=value1’ and ‘Key2=value2’. The key-value pair includes important information related to the query of the customer and as such, retaining such information as an unstructured variable facilitates in arriving at fairly accurate predictions related to the customer. Accordingly, the processor 302 may use the URL parser to clean transform URLs' to obtain separate tokens for domain names, hierarchy of journey, destination pages, and query strings.

Moreover, in some scenarios, the time stamps of each Web page may also be used to compute a time spent on each Web page. For example, if a customer has visited a Web page ‘P₁’ at time ‘T₁’ and subsequently visited another Web page ‘P₂’ at time ‘T₂’, then the processor 302 may be configured to compute the time spent on Web page ‘P₁’ as ‘T₂−T₁’ and store the time spent on each Web page as an unstructured variable as ‘Duration 1’ or ‘D₁’. In some scenarios, the processor 302 may also create bins (or classification categories) to classify time spent on various pages. The bins may be generated automatically, or supported based on configurable partitions. For example, a bin may be created to classify all time-spent values between one-second to one-minute duration. Similarly, another bin may be created to classify all time-spent values between one-minute and five-minute durations, and so on and so forth. Each of those bins may further serve as an unstructured variable. In some embodiments, page cluster labels may also be used instead of page categories.

The processor 302 may further be configured to generate a plurality of structured variables from structured data received corresponding to the customer's journey on the Website. For example, if the customer has used a mobile device with a ‘Windows 10®’ operating system and ‘Google Chrome®’ Web browser to access the Website, then the processor 302 may generate three structured variables as: ‘Mobile’, ‘Windows10’, and ‘Chrome’. In some example embodiments, the day, date, and time information of Website access may also be recorded as a structured variable. Further, the processor 302 may be configured to transform numeric structured variables into categorical variables. For example, date information may be transformed as ‘DAY9’ or time information may be transformed as ‘HOUR10’ and so on and so forth.

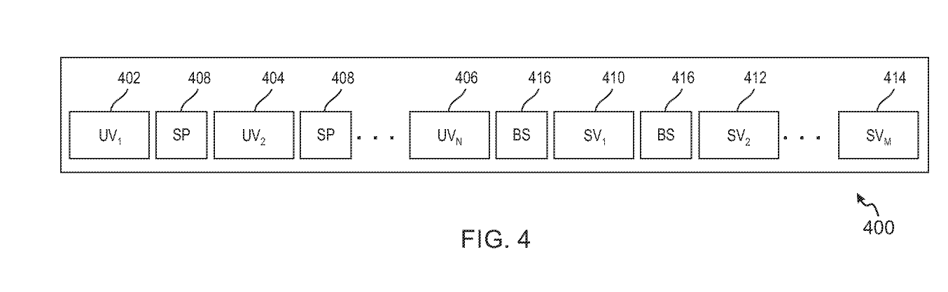

In at least one example embodiment, the processor 302 is configured to, with the content of the memory 304, cause the apparatus 300 to generate a session string by concatenating the plurality of unstructured variables and the plurality of structured variables. For example, the processor 302 may be configured to arrange textual forms of the plurality of structured variables and the plurality of unstructured variables serially to configure a freeform text string. Further, each variable in the freeform text string may be separated from a subsequent variable by a separator or a buffer string to generate the concatenated session string. The session string generated in such a manner serves as a textual representation of the customer's journey on the Website. An example session string format is explained with reference to FIG. 4.

Referring now to FIG. 4, an example format 400 of a session string generated corresponding to customer's journey on an enterprise Website is shown, in accordance with an embodiment of the invention. As explained with reference to FIG. 3, a plurality of unstructured variables and a plurality of structured variables are generated from unstructured data and structured data, respectively. The example format 400 exemplarily depicts the unstructured variables 1, 2 to N as UV₁, UV₂ and UV_{N} at 402, 404, and 406, respectively. Each unstructured variable is separated by a separator 408 (exemplarily depicted as ‘SP’ in the example format 400).

Further, the session string also includes structured variables 1, 2 to M exemplarily depicted as SV₁, SV₂, and SVM at 410, 412, 414, respectively. The structured variables are separated from the unstructured variables and from each other using a buffer string 416 (exemplarily depicted in the example format 400 as ‘BS’).

An example session string adhering to the example format 400 and generated for a customer journey on an enterprise Website involving visit to two URLs:
‘domain1.com/path1/destpage1.html?token1=value1&&token2=value2’ and
‘domain2.com/path2/destpage2.html?token3=value3&&token4=value4’
   and associated with Web browser ‘Mozilla’, a Windows 7 operating system and two binned top categories is depicted below:
‘Domain1.com/path1/destpage1.html token1=value1 token2=value2 # Domain2.com/path2/destpage2.html token3=value3 token4=value4 # # # # # destination_destpage1.html # # # # # destination_destpage2.html # # # # # browser_mozilla # # # # # os windows7 # # # # # binned_top_category1# # # # # # binned_top_category2’

As can be seen above, the session string concatenates both unstructured and structured variables. Further, the unstructured variables such as the URLs are separated by a separator ‘_#_’. Any such special character (or in some cases alphabetic, numeric or alphanumeric characters) may be used to separate the unstructured variables. Moreover, a buffer string of ‘ # # # # #’ is used to separate two structured variables and even the unstructured variables from the structured variables.

Such a session string serves as a textual representation of the customer's journey on the Website. The reduction of data from the Web log to an unstructured freeform text string enables use of standard text categorization tools to generate features from the session string, which may then be used for prediction purposes. Moreover, the session string captures all important information from the customer's activity on the Website while precluding the need to manually categorize Web pages and at the same time prevents losing rich information associated with customer activity on the Website that may be used for prediction purposes. It is understood that the format of the session string is explained herein for example purposes and that the concatenation of structured variables and unstructured variables may be performed in various ways while retaining the essence of information to be captured.

In some embodiments, the processor 302 is configured to add a prefix or a suffix variable to each, or one or more groups of unstructured variables. For example, each URL, key value pair, or page category may be prefixed with a progress-bin variable (indicative of the progress in a journey), session ID, etc. Further, different separators may be added to represent page transitions, session transitions, delays between pages, changes in interaction channels, and other such meaningful transitions in a journey. Additional interaction data from click stream data may also be added to session strings such as, link hovered, time spent on a form, time spent on a form field, text highlighted, area or text clicked on a Webpage, scroll up or scroll down events, backspace events, etc.

Referring now to FIG. 3, in at least one example embodiment, the processor 302 is configured to, with the content of the memory 304, cause the apparatus 300 to perform a text-based processing of the session string to generate a plurality of features. In an embodiment, the apparatus 300 is caused to perform at least one of text tokenization, text normalization, and text vectorization on elements of the session string for performing text-based processing of the session string to generate the plurality of features. The text-based processing of the session string is further explained in detail hereinafter.

In an embodiment, the text-based processing of the session string may involve performing tokenization (i.e. splitting) of the session string to generate tokens. In an example embodiment, the tokenization may be performed based on separators and buffer strings included in the session string. For example, elements of the session string, or more specifically, variables separated by separators/buffer strings may be selected to generate tokens. Further, the tokens may be subjected to one or more of text normalization techniques including spell correction, string replacements, replacements to specific word classes using Wordnets/thesaurus, stripping spaces, removing punctuations, removing numbers or replacing them by word classes, stemming, stop-word removal, point of sale (POS) tagging, and the like.

Further, the processor 302 may be configured to perform text vectorization using at least one of binary vectorizer, count vectorizer, Term frequency Inverse document frequency (TFIDF) vectorizer, or hash vectorizer at word or character level. In some embodiments, the processor 302 may be configured to perform association mining to determine association between tokens. For example, the processor 302 may be configured to compute text similarity scores such as edit distance, Levenshtein distance, cosine distance between (1) each page and previous n^{th} page; (2) each page category; and (3) previous nₜₕ page category and each session and previous n^{th} session to determine association there between. Thereafter, the processor 302 may be configured to perform custom vectorization, where the unigram tokens may be generated using combinations of one or more groups of unigrams based on user configured combinations of features in a preprocessing step, and these further may be vectorized using a unigram vectorizer to generate relevant features. The processor 302 may further be configured to reduce a number of features by using an appropriate feature selection method such as mutual information, Principal Component Analysis (PCA), Singular Value Decomposition (SVD), Chi-square, Gain ratio, Gini index, and the like. The reduced set of features is then used to build a prediction model configured to facilitate prediction of customer intentions or prediction of any other response variables related to the customer.

Some examples of the features that may be generated from the text-based processing of the session string include, but are not limited to, any combinations of words features such as n-grams, unigrams, bigrams and trigrams, word phrases, part-of-speech of words, sentiment of words, sentiment of sentences, position of words, customer keyword searches, customer click data, sequence of Web page visits, time spent on particular Web pages, and the like.

In at least one example embodiment, the processor 302 is configured to, with the content of the memory 304, cause the apparatus 300 to build at least one prediction model using the plurality of features. The at least one prediction model is configured to facilitate prediction of at least one response variable. In an embodiment, predicting a response variable may include predicting one of an intention of the customer, a persona of the customer, a sentiment of the customer, a likelihood of the customer to call, an outcome of a chat offer to the customer, a net promoter score (NPS), a customer satisfaction score (CSAT), and a net experience score (NES) for the customer. In some embodiments, predicting a response variable may include predicting a sale outcome or a no-sale outcome.

In an embodiment, the apparatus 300 is caused to train a prediction classifier using the plurality of the features to build the at least one prediction model for facilitating prediction of the at least one response variable. For example, in at least example embodiment, the processor 302 may be configured to provide the pruned set of features along with a response variable (i.e. variable to be predicted such as a buy/no-buy outcome, offer chat or not, etc.) to at least one classification algorithm based on machine learning or statistical modeling techniques. In an embodiment, the classification algorithm may be selected from among Naïve Bayes, Decision Trees, Random Forests, Support Vector machines (SVM), incremental learning, active learning, and the like. Also, ensembles of models may be used for text classification using a variety of voting schemes. As mentioned above, the response variable, for example an intention to be predicted/modeled, may relate to a purchase of a particular product, purchase of a number of products, a persona of the customer, a sentiment of the customer, a net promoter score (NPS), a customer satisfaction score (CSAT), a first call resolution (FCR), a predicted or an actual experience score for the customer, a customer's call or a chat interaction after a Web session, a queue, an agent's skill, a voice referral from a chat interaction, a chat transfer, an outcome of a following interaction with an interactive voice response (IVR) system, a voice call, a chat interaction, a degree of decidedness for sales, and the like. The classification algorithm (i.e. the prediction classifier) may be configured to assign weights to features based on their perceived respective contribution towards achieving a chosen response variable and compute an overall likelihood of occurrence of the response variable. The weights for the features may be chosen by an experienced user (for example, a field expert) or may be learnt by the apparatus 300 using machine learning by observing activity and subsequent response variable outcomes for a plurality of customers visiting the enterprise Website.

In an embodiment, the apparatus 300 is caused to refine built prediction models based on at least one of active learning and incremental learning. More specifically, a base version of the prediction model may be used for response variable prediction purposes, and thereafter based on learning from differences observed in predicted outcome and actual behavior of the customers, the prediction models may further be refined or fine-tuned to facilitate prediction of response variables with respect to customers visiting the enterprise Website.

The built models may then be used to for generating predictions of all customers visiting the enterprise Website. In at least one example embodiment, the predictions for the customers may be used for improving chances of sale or providing an improved browsing experience to the customers. In an illustrative example, the processor 302 is configured to determine whether a chat option may be offered to a customer on the Website, or to which chat agent a chat interaction may be routed based on the predicted intention of the customer. In another illustrative example, the processor 302 is configured retrieve all possible content that may be offered to the customer from the memory 304 based on the predicted intention of the customer. For example, the processor 302 may retrieve several content pieces including advertisements, widgets, news snippets, frequently asked questions (FAQ), and the like and provide appropriate content to the customer during an on-going journey.

Although the building of prediction models is described with respect to customer's journey on a Website, in some embodiments the apparatus 300 may be configured to receive unstructured data and structured data corresponding to a customer's journey on one or more enterprise interaction channels associated with an enterprise and thereafter build prediction models using techniques disclosed herein. The reception of data corresponding to multiple enterprise interaction channels is explained hereinafter.

In an illustrative embodiment, customers may interact with customer service representatives, such as human agents or virtual agents, over a voice interaction channel, a chat interaction channel, and the like. The voice agents or chat agents may associate on-going conversational content with appropriate tags, which may enable capture of information such as category of customer concern, concern resolution status, agent information, call transfers if any, time of the day/day of the week for the interaction, and the like. The tagged information may be recorded in a data gathering server in a customer support center associated with the enterprise voice or chat agents. In some example scenarios, the data gathering servers may also be in operative communication with personal devices of the customers (for example, in remote communication with native mobile applications, voice assistants etc. included within the personal devices of the customers) to capture information related to the customers. Accordingly, the data gathering servers may capture interaction related information and in some cases, personal information such as name, billing address, email accounts, contact details, location information, social media accounts, etc. for each customer. The data gathering servers may capture such information related to plurality of customers of the enterprise.

The data retrieved corresponding to the plurality of customers of the enterprise may include structured data and unstructured data. In an illustrative example, data related to device, browser, access times, and the like may be captured in a structured manner for the plurality of customers visiting the Website. However, data retrieved corresponding to customer's voice conversations or chat logs may differ from one customer to another and, as such, configure the unstructured data. The retrieved data may further include numerical information, such as time of the day, date of the month, phone number, credit card information, and the like.

Accordingly, the communication interface 308 of the apparatus 300 may be configured to receive unstructured data and structured data corresponding to a customer's journey on one or more enterprise interaction channels associated with an enterprise. In an embodiment, an enterprise interaction channel may correspond to an enterprise Website. Accordingly, the structured data and the unstructured data corresponding to the customer's journey on the Website may be received in form of a Web log. The apparatus 300 may be caused to generate a plurality of unstructured variables from the unstructured data and a plurality of structured variables from the structured data. The plurality of unstructured variables and the plurality of structured variables may be concatenated to generate a session string, as explained with reference to FIGS. 3 and 4. The session string in this case configures a textual representation of the customer's journey on the one or more enterprise interaction channels. The apparatus 300 may further caused to perform a text-based processing of the session string to generate a plurality of features and build at least one prediction model using the plurality of features. The text-based processing of the session string for generation of features and the building of prediction models using the features may be performed as explained with reference to FIG. 3 and is not explained again herein. Further, as explained above, the prediction models may be used for prediction of response variables, such as predicting an intention of the customer, a persona of the customer, a sentiment of the customer, a likelihood of the customer to call, an outcome of a chat offer to the customer, a net promoter score (NPS), a customer satisfaction score (CSAT), or a net experience score (NES) for the customer.

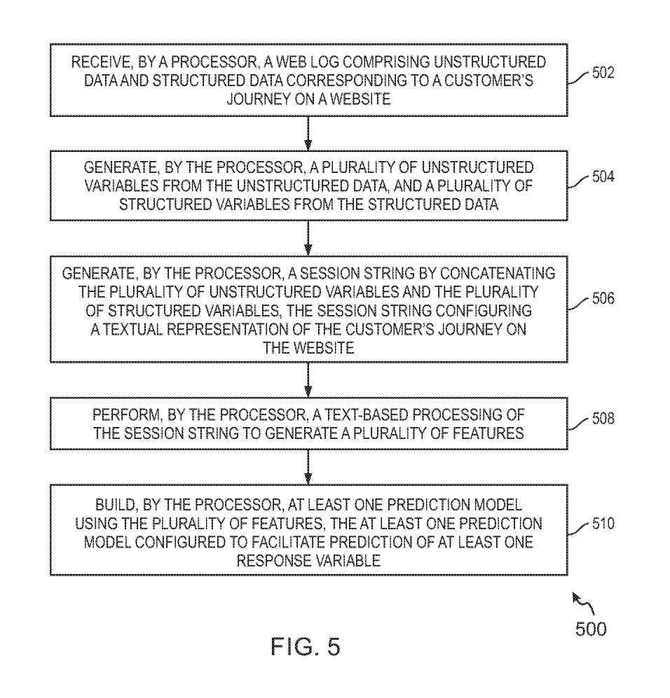

A method for building prediction models is explained with reference to FIG. 5.

FIG. 5 is a flow diagram of an example method 500 for building prediction models from a customer Web log, in accordance with an embodiment of the invention. The method 500 depicted in the flow diagram may be executed by, for example, the apparatus 300 explained with reference to FIGS. 3 to 4. Operations of the flowchart, and combinations of operation in the flowchart may be implemented by, for example, hardware, firmware, a processor, circuitry and/or a different device associated with the execution of software that includes one or more computer program instructions. The operations of the method 500 are described herein with help of the apparatus 300. For example, one or more operations corresponding to the method 500 may be executed by a processor, such as the processor 302 of the apparatus 300. Although the one or more operations are explained herein to be executed by the processor alone, the processor is associated with a memory, such as the memory 304 of the apparatus 300, which is configured to store machine executable instructions for facilitating the execution of the one or more operations. The operations of the method 500 can be described and/or practiced by using an apparatus other than the apparatus 300. The method 500 starts at operation 502.

At operation 502 of the method 500, a Web log including unstructured data and structured data corresponding to a customer's journey on a Website is received by a processor, such as the processor 302 of the apparatus 300 explained with reference to FIGS. 3 and 4. In an embodiment, the structured data captured corresponding to the customer's journey on the Website includes information related to at least one of a type of device used by the customer for accessing the Website, an operating system associated with the device, a type of Web browser used for accessing the Website, and a time-stamp associated with the Website access. In an embodiment, unstructured data captured corresponding to a customer's journey on the enterprise Website may include information such as Web pages visited on the Website, images viewed, hyperlinks accessed, mouse roll-over events, clickstream data, keystroke patterns, and the like. In an illustrative example, content pieces such as images, hyperlinks, URLs, and the like, displayed on an enterprise Website may be associated with Hypertext Markup Language (HTML) tags or JavaScript tags that are configured to be invoked upon user selection of tagged content. The information corresponding to the customer's activity on the enterprise Website may then be captured by recording an invoking of the tags in a Web server (i.e. a data gathering server) hosting the enterprise Website. In some embodiments, a socket connection may be implemented to capture all information related to the customer activity on the Website.

In at least one example embodiment, complete Uniform Resource Locators (URLs) of Web pages visited by the customer during the customer's journey on the Website may be captured. The URLs of the Web pages may be captured as part of unstructured data. Capturing complete URLs provides several advantages as explained with reference to FIG. 3. In at least one example embodiment, the structured data and the unstructured data captured corresponding to the customer's journey on the Website may be recorded in form of a Web log. In at least one example embodiment, the captured complete URLs may be recorded in an as-is form as unstructured data in the Web log.

At operation 504 of the method 500, a plurality of unstructured variables and a plurality of a plurality of structured variables are generated from the unstructured data and the structured data, respectively, by the processor using the Web log. In an illustrative example, if the customer executes a query on the enterprise Website such that the query results in an URL exemplarily depicted as follows:
www.mypersonalbanking.com/us/en/myaccounts.html?token1=value1&&token2=value2′

Then, in such a scenario, a URL parser may be used to parse the above URL to generate three unstructured variables as follows:
‘www.mypersonalbanking.com/en/us/myaccounts.html?’; ‘Key1=value1’ and ‘Key2=value2’.

The key-value pair includes important information related to the query of the customer and as such, retaining such information as an unstructured variable facilitates in arriving at fairly accurate predictions related to the customer. Accordingly, the processor may use th4e URL parser to clean transform URLs' to obtain separate tokens for domain names, hierarchy of journey, destination pages, query strings, time spent on each Web page, and the like.

The processor may further be configured to generate a plurality of structured variables from structured data received corresponding to the customer's journey on the Website. For example, if the customer has used an Apple iPAD® device with a ‘Apple iOS®’ operating system and ‘Mozilla Firefox®’ Web browser to access the Website, then the processor 302 may generate three structured variables as: ‘Tablet’, ‘iOS7’, and ‘Firefox’. In some example embodiments, the day, date, and time information of Website access may also be recorded as a structured variable. Further, the processor 302 may be configured to transform numeric structured variables into categorical variables. For example, date information may be transformed as ‘DAY9’ or time information may be transformed as ‘HOUR10’ and so on and so forth.

At operation 506 of the method 500, a session string is generated by the processor by concatenating the plurality of unstructured variables and the plurality of structured variables. The session string configures a textual representation of the customer's journey on the Website. In an embodiment, textual forms of the plurality of structured variables and the plurality of unstructured variables are serially arranged to configure a freeform text string, where each variable is separated from a subsequent variable in the freeform text string by at least one of a separator and a buffer string to generate the concatenated session string. The session string serves as a textual representation of the customer's journey on the Website. The generation of session string may be performed as explained with reference to FIG. 4. As explained above, the session string captures all important information from the customer's activity on the Website while precluding the need to manually categorize Web pages and at the same time preventing the loss of rich information associated with customer activity on the Website that may be used for prediction purposes.

At operation 508 of the method 500, a text-based processing of the session string is performed by the processor to generate a plurality of features. In an embodiment, at least one of text tokenization, text normalization, and text vectorization on elements of the session string are performed for text-based processing of the session string to generate the plurality of features. In an embodiment, the text-based processing of the session string may involve performing tokenization (i.e. splitting) of the session string to generate tokens. In an example embodiment, the tokenization may be performed based on separators and buffer strings included in the session string. The tokens may be subjected to one or more of text normalization techniques including spell correction, string replacements, replacements to specific word classes using Wordnets/thesaurus, stripping spaces, removing punctuations, removing numbers or replacing them by word classes, stemming, stop-word removal, point of sale (POS) tagging, and the like.

The text vectorization may be performed using at least one of binary vectorizer, count vectorizer, Term frequency Inverse document frequency (TFIDF) vectorizer, or hash vectorizer at word or character level. In an embodiment, text vectorization may involve custom vectorization, where the unigram tokens may generated using combinations of one or more groups of unigrams based on user configured combinations of features in a preprocessing step, and these further may be vectorized using a unigram vectorizer to generate relevant features. A number of features may be reduced by using an appropriate feature selection method, such as mutual information, Principal Component Analysis (PCA), Singular Value Decomposition (SVD), Chi-square, Gain ratio, Gini index, and the like. The reduced set of features may then used to build a prediction model configured to facilitate prediction of customer intentions or prediction of any other response variables related to the customer.

At operation 510 of the method 500, at least one prediction model is built by the processor using the plurality of features. The at least one prediction model is configured to facilitate prediction of at least one response variable. In an embodiment, predicting a response variable includes predicting one of an intention of the customer, a persona of the customer, a sentiment of the customer, a likelihood of the customer to call, an outcome of a chat offer to the customer, a net promoter score (NPS), a customer satisfaction score (CSAT), and a net experience score (NES) for the customer. In some embodiments, predicting a response variable may include predicting a sale outcome or a no-sale outcome. In an embodiment, a prediction classifier may be trained using the plurality of the features to build the at least one prediction model for facilitating prediction of the at least one response variable. For example, in at least example embodiment, the processor 302 may be configured to provide the pruned set of features along with a response variable (i.e. variable to be predicted such as a buy/no-buy outcome, offer chat or not, etc.) to at least one classification algorithm based on machine learning or statistical modeling techniques. In an embodiment, the classification algorithm may be selected from among Naïve Bayes, Decision Trees, Random Forests, Support Vector machines (SVM), incremental learning, active learning, and the like. Also, ensembles of models may be used for text classification using a variety of voting schemes. In an embodiment, the built prediction model may further be refined based on at least one of active learning and incremental learning, as explained with reference to FIG. 3.

Although the method 500 is explained with reference to a single customer visiting a Website, the method 500 may be extended to predict response variables for a plurality of customers of the enterprise.

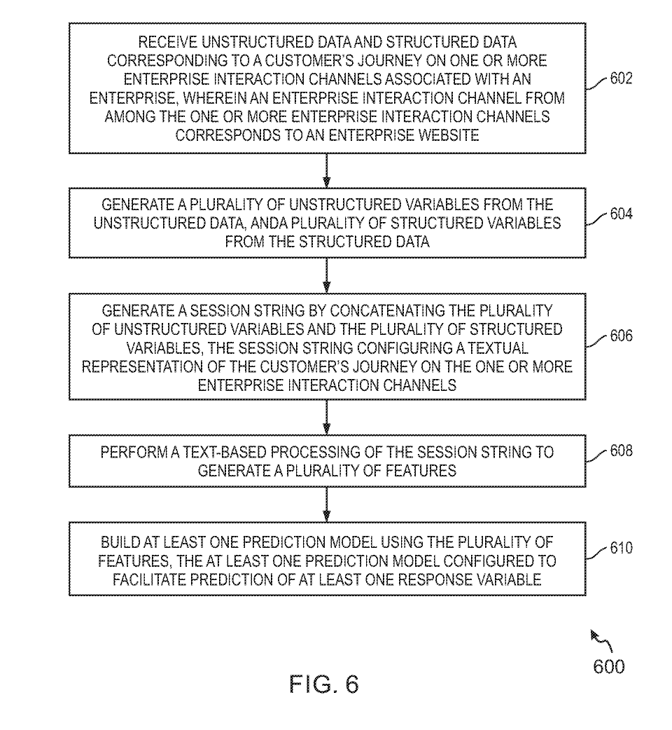

Another method for building prediction models for customers of an enterprise is explained with reference to FIG. 6.

FIG. 6 is a flow diagram of an example method 600 for building prediction models for customers of an enterprise in accordance with another embodiment of the invention. The method 600 depicted in the flow diagram may be executed by, for example, the apparatus 300 explained with reference to FIGS. 3 and 4. Operations of the flowchart, and combinations of operation in the flowchart, may be implemented by, for example, hardware, firmware, a processor, circuitry, and/or a different device associated with the execution of software that includes one or more computer program instructions. The method 600 starts at operation 602.

At operation 602 of the method 600, unstructured data and structured data corresponding to a customer's journey on one or more enterprise interaction channels associated with an enterprise is received. The data retrieved corresponding to the plurality of customers of the enterprise may include structured data and unstructured data. In an embodiment, an enterprise interaction channel from among the one or more enterprise interaction channels corresponds to an enterprise Website. Accordingly, the structured data and the unstructured data corresponding to the customer's journey on the Website may be received in form of a Web log.

At operation 604 of the method 600, a plurality of unstructured variables and a plurality of structured variables are generated from the unstructured data and the structured data, respectively. At operation 606 of the method 600, a session string is generated by concatenating the plurality of unstructured variables and the plurality of structured variables. The session string configures a textual representation of the customer's journey on the one or more enterprise interaction channels. The generation of the unstructured and structured variables, and concatenation of such variables to configure the session string may be performed as explained with reference to FIGS. 3 and 4, and is not explained again herein.

At operation 608 of the method 600, a text-based processing of the session string is performed to generate a plurality of features. At operation 610 of the method 600, at least one prediction model is built using the plurality of features, the at least one prediction model configured to facilitate prediction of at least one response variable. The text-based processing of the session string to generate features and building of prediction models using those features may be performed as explained with reference to FIGS. 3 and 5 and is not explained again herein.

Various embodiments disclosed herein provide numerous advantages. The techniques disclosed herein provide a method for building prediction models from Web logs using text mining based approach. Using the text mining based approach facilitates in better handling of structured and unstructured data and the use of simple preprocessing approaches enable efficient handling of event sequences, and the like. The techniques disclosed herein may be used to build models for predicting customer intents such as intents related to propensity to chat, propensity to purchase, propensity to call, containment of calls on Web or chat, queue routing models, and the like. Additionally, this approach can be extended to multiple channels for real-time updating of models, or even batch-wise updation of models (at specified intervals). Such building of prediction models precludes time and manual effort in categorizing Web pages and exploratory data analysis. Moreover, unstructured data is captured and combined with structured data for a more efficient use thereof for facilitating building of prediction models.

In some embodiments, a real-time omnichannel learning system may be configured to tune models to learn in real-time. The real-time omnichannel learning system may use information from active/incremental learning based on session string determined for an omnichannel journey and the response variable determined from logged data from customer, agent, system logged events, or collaborative tagging platform, etc. For example, if following a Web journey, a customer chats, and the customer's intent is tagged through the platform. Models can learn from such tags on the fly, to then predict the intent of another customer who goes through a similar journey.

Although the present invention has been described with reference to specific exemplary embodiments, it is noted that various modifications and changes may be made to these embodiments without departing from the broad spirit and scope of the invention. For example, the various operations, blocks, etc. described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits, for example application specific integrated circuit (ASIC) circuitry and/or in Digital Signal Processor (DSP) circuitry.

Particularly, the apparatus 300, the processor 302, the memory 304, the I/O module 306, and the communication interface 308 may be enabled using software and/or using transistors, logic gates, and electrical circuits (for example, integrated circuit circuitry, such as ASIC circuitry). Various embodiments of the present invention may include one or more computer programs stored or otherwise embodied on a computer-readable medium, wherein the computer programs are configured to cause a processor or computer to perform one or more operations (for example, operations explained herein with reference to FIGS. 5 and 6). A computer-readable medium storing, embodying, or encoded with a computer program, or similar language, may be embodied as a tangible data storage device storing one or more software programs that are configured to cause a processor or a computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY®_ Disc), and semiconductor memories, such as mask ROM, PROM (programmable ROM), EPROM (erasable PROM), flash memory, RAM (random access memory), etc. Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers), or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claimed invention.

1. A computer-implemented method, comprising:
receiving, by a processor, a Web log comprising unstructured data and structured data corresponding to a customer's journey on a Website;
generating, by the processor, using the Web log:
a plurality of unstructured variables from the unstructured data, and
a plurality of structured variables from the structured data;
generating, by the processor, a session string by concatenating the plurality of unstructured variables and the plurality of structured variables, the session string configuring a textual representation of the customer's journey on the Website;
performing, by the processor, a text-based processing of the session string to generate a plurality of features;
building, by the processor, at least one prediction model using the plurality of features; and
using, by the processor, the at least one prediction model facilitate prediction of at least one response variable.

2. The method of claim 1, wherein the structured data corresponding to the customer's journey on the Website comprises information related to at least one of a type of device used by the customer for accessing the Website, an operating system associated with the device, a type of Web browser used for accessing the Website, and a time-stamp associated with the Website access.

3. The method of claim 1, further comprising:
causing, by the processor, capture of complete Uniform Resource Locators (URLs) of Web pages visited by the customer during the customer's journey on the Website, the URLs of the Web pages comprising at least a part of the unstructured data.

4. The method of claim 3, further comprising:
parsing the URLs, by the processor, to obtain tokens corresponding to at least one of domain names, hierarchy of journey, destination pages, and query strings, wherein each token from among the tokens obtained by parsing the URLs comprises an unstructured variable from among the plurality of unstructured variables.

5. The method of claim 1, wherein the unstructured variables generated from the unstructured data comprises at least one unstructured variable from among variables related to a time spent on each Web page, a sequence of Web page visits, and a search query entered by the customer during the customer's journey on the Website.

6. The method of claim 1, wherein predicting a response variable from among the at least one response variable comprises predicting one of an intention of the customer, a persona of the customer, a sentiment of the customer, a likelihood of the customer to call, an outcome of a chat offer to the customer, a net promoter score (NPS), a customer satisfaction score (CSAT), and a net experience score (NES) for the customer.

7. The method of claim 1, wherein predicting a response variable from among the at least one response variable comprises predicting one of a sale outcome and a no-sale outcome.

8. The method of claim 1, further comprising:
arranging textual forms of the plurality of structured variables and the plurality of unstructured variables serially to configure a freeform text string, wherein each variable is separated from a subsequent variable in the freeform text string by at least one of a separator and a buffer string to generate the concatenated session string.

9. The method of claim 1, further comprising:
performing at least one of text tokenization, text normalization, and text vectorization on elements of the session string to effect text-based processing of the session string to generate the plurality of features.

10. The method of claim 1, further comprising:
training a prediction classifier using the plurality of the features to build the at least one prediction model for facilitating prediction of the at least one response variable.

11. The method of claim 1, further comprising:
refining the built at least one prediction model based on at least one of active learning and incremental learning.

12. The method of claim 1, wherein the customer's journey on the Website comprises one or more visits to the Website.

13. An apparatus, comprising:
at least one processor; and
a memory having stored therein machine executable instructions, that when executed by the at least one processor, cause the apparatus to:
receive a Web log comprising unstructured data and structured data corresponding to a customer's journey on a Website;
generate using the Web log:
a plurality of unstructured variables from the unstructured data, and
a plurality of structured variables from the structured data;
generate a session string by concatenating the plurality of unstructured variables and the plurality of structured variables, the session string configuring a textual representation of the customer's journey on the Website;
perform a text-based processing of the session string to generate a plurality of features;
build at least one prediction model using the plurality of features; and
use the at least one prediction model to facilitate prediction of at least one response variable.

14. The apparatus of claim 13, wherein the apparatus is further configured to:
cause capture of complete Uniform Resource Locators (URLs) of Web pages visited by the customer during the customer's journey on the Website, the URLs of the Web pages comprising at least a part of the unstructured data.

15. The apparatus of claim 14, wherein the apparatus is further caused to:
parse the URLs to obtain tokens corresponding to at least one of domain names, hierarchy of journey, destination pages and query strings, wherein each token from among the tokens obtained by parsing the URLs comprises an unstructured variable from among the plurality of unstructured variables.

16. The apparatus of claim 13, wherein predicting a response variable from among the at least one response variable comprises predicting one of an intention of the customer, a persona of the customer, a sentiment of the customer, a likelihood of the customer to call, an outcome of a chat offer to the customer, a net promoter score (NPS), a customer satisfaction score (CSAT) and a net experience score (NES) for the customer.

17. The apparatus of claim 13, wherein the apparatus is further caused to:
arrange textual forms of the plurality of structured variables and the plurality of unstructured variables serially to configure a freeform text string, wherein each variable is separated from a subsequent variable in the freeform text string by at least one of a separator and a buffer string to generate the concatenated session string.

18. The apparatus of claim 13, wherein the apparatus is further caused to:
perform at least one of text tokenization, text normalization, and text vectorization on elements of the session string for performing text-based processing of the session string to generate the plurality of features.

19. The apparatus of claim 13, wherein the apparatus is further caused to:
train a prediction classifier using the plurality of the features to build the at least one prediction model for facilitating prediction of the at least one response variable.

20. A computer-implemented method comprising:
receiving, by a processor, unstructured data and structured data corresponding to a customer's journey on one or more enterprise interaction channels associated with an enterprise, wherein an enterprise interaction channel from among the one or more enterprise interaction channels corresponds to an enterprise Website;
generating, by the processor:
a plurality of unstructured variables from the unstructured data, and
a plurality of structured variables from the structured data;
generating, by the processor, a session string by concatenating the plurality of unstructured variables and the plurality of structured variables, the session string configuring a textual representation of the customer's journey on the one or more enterprise interaction channels;
performing, by the processor, a text-based processing of the session string to generate a plurality of features;
building, by the processor, at least one prediction model using the plurality of features; and
using, by the processor, the at least one prediction model to facilitate prediction of at least one response variable.

21. The method of claim 20, further comprising:
causing, by the processor, capture of complete Uniform Resource Locators (URLs) of Web pages visited by the customer during the customer's journey on the enterprise Website, the URLs of the Web pages comprising at least a part of the unstructured data.

22. The method of claim 21, further comprising:
parsing the URLs, by the processor, to obtain tokens corresponding to at least one of domain names, hierarchy of journey, destination pages, and query strings, wherein each token from among the tokens obtained by parsing the URLs comprises an unstructured variable from among the plurality of unstructured variables.

23. The method of claim 20, further comprising:
training a prediction classifier using the plurality of the features to build the at least one prediction model for facilitating prediction of the at least one response variable.

24. The method of claim 20, wherein predicting a response variable from among the at least one response variable comprises predicting one of an intention of the customer, a persona of the customer, a sentiment of the customer, a likelihood of the customer to call, an outcome of a chat offer to the customer, a net promoter score (NPS), a customer satisfaction score (CSAT), and a net experience score (NES) for the customer.
